(19) United States
(12) Patent Application Publication
(10) Pub. No.: US 2021/0221277 A1
(43) Pub. Date: Jul. 22, 2021

(54) LOAD-STABILIZING WEB

(71) Applicant: Uwe SCHOEBEL, Froendenberg (DE)

(72) Inventor: Uwe SCHOEBEL, Froendenberg (DE)

(21) Appl. No.: 15/733,937

(22) PCT Filed: Jun. 18, 2019
(86) PCT No.: PCT/EP2019/066035

§ 371 Date: Dec. 16, 2020

(30) Foreign Application Priority Data
Jun. 25, 2018 (DE) 20 2018 103 592.4

(51) Int. Cl. B60P 7/08

(52) U.S. Cl. CPC B60P 7/0876

(57) ABSTRACT

The invention relates to a flat securing means, in particular a securing net, for securing a load while the load is being transported on the loading surface (6) of a vehicle. The securing means is equipped with a size-variable flexible securing surface (1, 2) and stop devices (7) provided on the edge side of the securing surface (1, 2) for releasably fixing the securing surface (1, 2) to side walls (5) of the vehicle. According to the invention, a tightening device (8 to 11, H) is provided which converts the flexible securing surface (1, 2) at least from a stretched securing position into a folded storage position and back.

The invention relates to a load-stabilizing web, in particular a net for securing a load during transport in a cargo area of a vehicle, comprising a variable-size, flexible holding zone having side edges provided with attachment fittings for releasable fixation of the holding zone on side walls of the vehicle.

A load-stabilizing web of the type described above usually ensures that a load on a load surface of the vehicle equipped with it or several loads does not move or only moves a little due to dynamic driving processes. To do this, the load-stabilizing web serves for longitudinal subdivision of the cargo area and is secured on both the vehicle's side walls. For this purpose, the vehicle can, for example, be provided with rails or openings in the side walls. Anchors may be adapters as disclosed for example in EP 3 154 820 of the applicant in detail. Of course, this does not apply as a limitation.

A similar flat load-stabilizing web is known from German utility model 20 2016 104 193. Here in addition to the flexible holding zone there is a safety bar connected to the net. The safety bar has a continuously adjustable adapter. That way one can fix a loop or the safety bar, for example on a side wall of the vehicle.

Other and comparable load-stabilizing webs are described in DE 20 2015 100 289 or DE 20 2012 101 216 of applicant. In the latter case, lashing straps serve to adapt to the corresponding load.

With a flat load stabilizer according to U.S. Pat. No. 2,455,237 of the structure described above there is the possibility of making the flexible holding zone variable in size depending on the load to be secured. Different designs of the flexible holding zone are conceivable, among other things, such that the flexible holding zone is folded onto itself.

Besides the possibility of making the flexible holding zone of variable size to adapt to differently sized loads, there is the problem of opening and closing the holding zone in order to make it possible to access the load on the other side of it. In addition, it is important to adjust the position of the load-stabilizing web inside the cargo area. To do this, individual attachment fittings must first be detached from the side walls and then the flexible holding zone is moved to a different desired location and secured there. Since the load-stabilizing web depending on load size must have an area of several square meters, up to 10 m² and more, handling it is often not easy, especially since for example only the driver who operates the truck is available. In addition to cargo areas of trucks, trailers and even containers need to be equipped with the load stabilizers. Here the invention aims at an overall remedy.

The object of the invention is to provide such a flat load stabilizer that is easy to handle and in particular to move from one position to another in a cargo area.

To attain this object a standard load stabilizer is provided with gathering means that can move the flexible holding zone between an extended holding position and a folded storage position.

According to an initial but not only primary feature of the invention the flexible holding zone can be adjusted for different dimensions of the cargo. In addition, the gathering means ensures that the flexible holding zone can be folded. The flexible holding zone can quickly and easily be moved by the gathering means between at least two positions. The first position of the flexible holding zone is its holding position. The extended position corresponds to the fact that the flexible holding zone typically is at its largest or almost largest surface area and, when in this holding position, is spanned between opposite side walls of the vehicle.

This allows the flexible holding zone in the holding position to prevent the cargo in front of or behind it from slipping significantly. To this end the flexible holding zone ensures subdivision of the loading space in the desired location.

In addition to the flexible holding zone assuming the holding position, it can assume the folded position. In this folded position the flexible holding zone is usually in reserve folded several times like an accordion. This is effected by the gathering means. The storage position also corresponds mostly to the fact that in it the flexible holding zone is folded up and raised. This means that the folded storage position makes a passageway available. In addition, the load-stabilizing web can in this position be particularly easily and quickly, for example, separated from the side walls and moved to a different position. This makes handling and installation significantly easier compared to previous procedures.

According to an advantageous embodiment, the gathering means has at least one gathering cable connected to a lower edge of the holding zone in the load-retaining position. The gathering cable is connected with one end to the lower edge of the holding zone. In addition the gathering cable has a free end equipped with a handle. In addition, the gathering means is advantageously and additionally provided with at least one deflector for the gathering cable. The deflector is normally provided at the top of the load zone.

Usually there are several gathering cables, each with one end connected to the lower edge of the load zone. The several gathering cables are uniformly spaced from one another at the upper edge of the load zone. In addition the cables usually run parallel to each other in the gathering direction. The gathering direction usually corresponds to a vertical direction and is consequently perpendicular to the previously mentioned load zone of the load space of the vehicle. In addition, the gathering cables run through respective deflectors on the upper edge of the holding zone.

In order not to have to handle and actuate the cables individually, they are all connected to a coupling. This also makes it necessary to use gathering cables of different lengths, depending on their respective positions at the lower edge of the holding zone. By joining together the cables at the coupling, the gathering cables are actuated jointly with the help of a (single) handle. For this purpose, the handle may be for example a loop, for example held by an operator and is usually actuated by being pulled to move the flexible holding zone from its extended holding position into the folded storage position.

The handle can in this context be equipped with a fastener. The fastener is used for detachable fixation of the handle and consequently of the gathering means as a whole for example on one of the two opposite side walls. In this way, the load-stabilizing web is maintained overall and it is ensured that the flexible holding zone remains in its folded storage. Once the fastener is detached for example from the side wall, the gathering means releases and the flexible holding zone can drop by gravity from the one previously occupied folded storage position into its extended holding position.

That above-described coupling is generally above the handle. The multiple deflectors for each of the gathering cables are in a row at the upper edge of the holding zone. The coupling is positioned adjacent the first deflector. Be this way the individual deflectors gathering cables pass over the first deflector in the row of deflectors and are gathered at the coupling. The handle is outward of the coupling so that an operator with the help of the (single) handle can act automatically and jointly on all the cables. This ensures that the lower edge of the flexible holding zone is lifted smoothly from a load surface and with tipping into the folded storage position.

So that the single gathering cable or the several gathering cables are properly guided on the flexible holding zone each cable passes in the gathering direction through guides fixed on the flexible holding zone. Each guide can be a loop, an eyelet, a bow, or the like. of course are such combinations possible.

The gathering cable as such is not necessarily cylindrical or rope-like. Because the term gathering cable is to be interpreted in a wide context of the invention to basically include such as a plastic tape, for example a plastic fabric tape. As a rule, the gathering cable is a steel or synthetic cable. To minimize friction, the steel cable can also be for example coated with plastic. Of course combinations are possible.

According to a more advantageous embodiment, the flexible holding zone is provided with an additional structural element at least at the upper edge of the flexible holding zone. This additional structural element can for example be a plastic strap, a safety bar, etc. If a safety bar is used, the one or more deflectors for one or the other realize several gathering cables can be on the safety bar. In addition, the cables can be protected in this way inside the safety bar, at least at the upper edge of the flexible holding zone.

This safety bar also has the further advantage that with its help the load-stabilizing web overall especially easily, quickly, and intuitively can subdivide the cargo space or the cargo area of the vehicle equipped with it. For this purpose it is conceivable that each of long side walls of the loading space or the vehicle extending parallel to each other is provided with a respective rail. The safety bar can be guided on or in these rails. Normally the relevant rails are at upper end region of the respective long side wall.

This way the ends of the safety bar of the load-stabilizing web are guided in the rails on both sides and fixable at practically any point along the cargo area to the respective rail to subdivide the cargo space care at the intended place. In this way it is then only necessary to move the holding zone from the previously folded storage position into its extended holding position. This can be done in the simplest case accomplish that by unhooking the fastener-equipped handle and let gravity pull down the flexible holding automatically from the folded storage position into the extended holding position.

In addition, there can be another possibility for dividing or opening the flexible holding zone. For this purpose one or more clamps or comparable separation devices can be provided. Mostly the flexible holding zone can split or open. This allows the flexible holding zone, for example, to be opened to give unhindered access to the cargo area, for example through the flexible holding zone enable.

Due to the possibility of splitting the flexible holding zone, in addition, its installation is generally simplified. Since there are generally one or more clamps on the one hand, the flexible holding zone can be installed between the opposite side walls and on the other hand can be release therefrom by loosening the attachment fittings of the holding zone loosen from the wall or removing them removed from the corresponding openings in the side wall. This, as it were, relieved state of the flexible locking area can be maintained in the folded storage position. To this end the handle with its associated fastener in this case should not be fixed to the side wall, but rather to the upper edge of the holding zone. For example, by fitting the fastener with a hook.

Thus a load-stabilizing web is proposed with which not only can one cargo space vehicle flawlessly and at practically any point be subdivided. But the cargo space subdivision is done easily and intuitively and can be easily by a single person. To change position of the load-stabilizing web, the gathering means first folds the flexible holding zone into its folded storage position upper. Following this, the load-stabilizing web as a whole is secured at the desired new position by the attachment fittings for example, set on the side walls of the vehicle. If an additional structural element in this context and, for example, a safety bar is used, it can simply be slid along the rails at the upper regions of the side walls.

In any case, the flat web stabilizer can be is flawlessly and flexibly fixed at the desired position in the cargo space. Then the handle is used to release the gathering means so that the flexible holding zone is released and drops by gravity from its folded storage position automatically into the extended holding position. Then the load-stabilizing web is immediately ready for use and can assume the desired holding function. These are the significant advantages.

The invention is described in more detail in the following with reference drawing of a merely schematically shown embodiment. Therein:

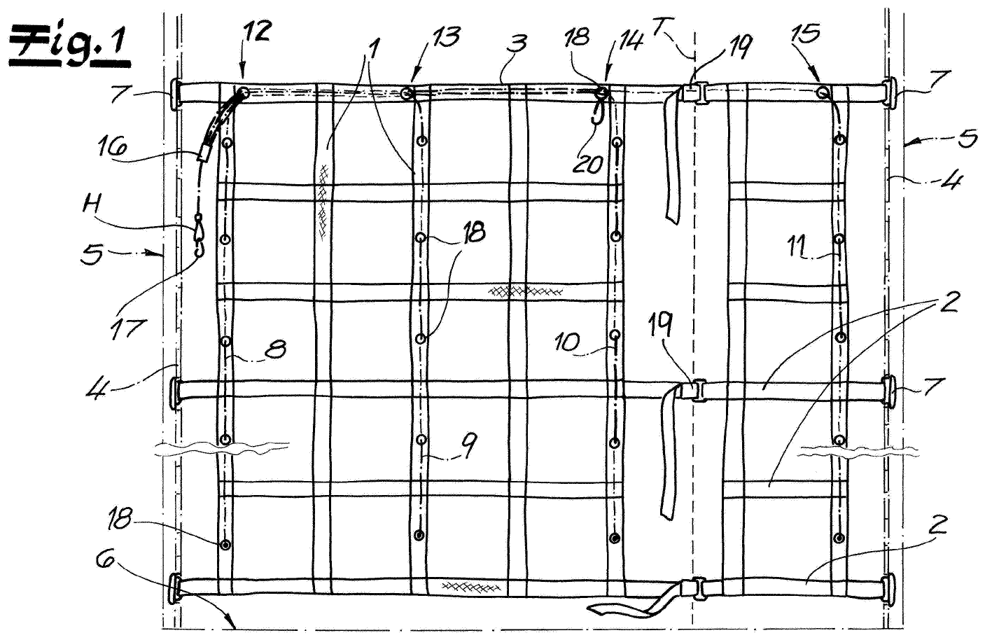

FIG. 1 shows the load-stabilizing web in an extended holding position,

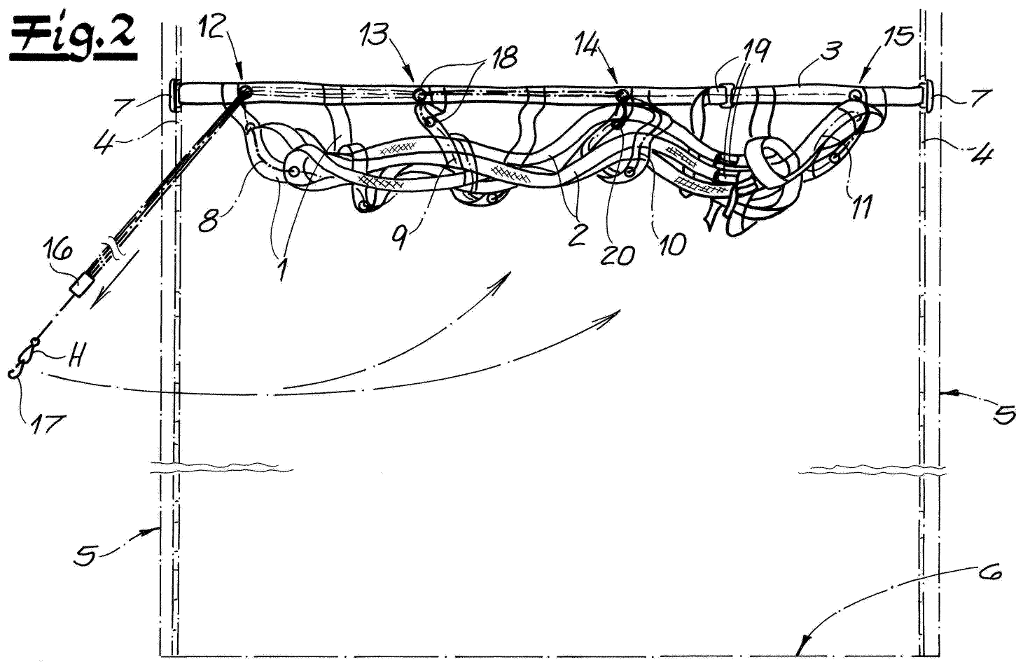

FIG. 2 shows the web of FIG. 1 in a folded-up storage position, and

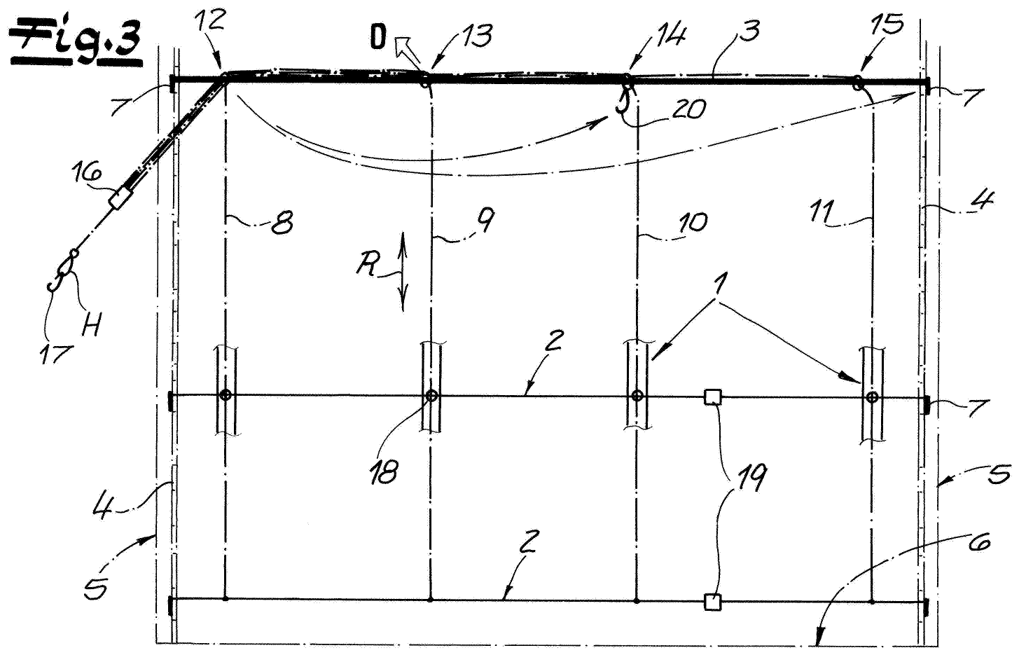

FIG. 3 schematically shows the object according to FIGS. 1 and 2.

In the figures, a load-stabilizing web is shown that in the present case is a cargo net. The cargo net is made of plastic straps 1, 2. The plastic straps include vertical straps 1 and horizontal straps 2 connected to each other at crossing points. This can be done in several possible ways forming connections, for example by sewing, gluing, etc.

The straps or plastic straps 1, 2 define a flexible holding zone 1, 2 of variable area. Furthermore according to this embodiment and optionally an additional such structural element 3 is provided at least at the upper edge of the flexible holding zone 1, 2. This additional structural element 3 is as shown in FIG. 1 a plastic strap. In principle, however, it can include a rigid load bar 3 as shown in FIG. 3. The load bar 3 may be slidable in horizontally extending rails 4 at upper edges of the vertical side walls 5 delimiting the load compartment of a vehicle. The vehicle is illustrated by the two long side walls 5 extending in a longitudinal direction 5 above a surface 6 on which cargo is loaded and prevented from moving with help of the load-stabilizing web.

The flexible holding zone 1, 2 or the load-stabilizing web also has attachment fittings 7 at outer vertical edges of the load zone 1, 2. The attachment fittings 7 can be hooks, eyelets or adapters, as in the above cited EP 3,154,820. The edge attachment fittings 7 can be detached from the side walls 5 of the unillustrated vehicle. These are side walls 5 with rails, for example provided with holes provided. In principle, the however, such holes could be made directly in the side walls 5. In any case, the flexible holding zone 1, 2 and consequently the load-stabilizing web serve overall for subdivision of the load space of the vehicle. The load-stabilizing web can be fixed longitudinally of the load surface 6 by the attachment fittings 7 in the seats in the side walls 5. It should be emphasized that in the following the illustrated load-stabilizing web is not restricted to a net with the intersecting straps 1, 2. The cargo net can basically be a small-mesh rope net. Alternatively the flexible holding zone 1, 2 could be a plastic tarpaulin, a plastic fabric or something else like a flexible textile or non-textile flat element.

According to the invention and of particular importance now in addition and in addition to the flexible one holding zone 1, 2 and the edge-mounted attachment fittings 7 there is a gathering means 8 to 11, H. With the help of this gathering means 8 to 11, H the flexible holding zone 1, 2 can move between a spread-out holding position shown in FIG. 1 and a gathered position as shown in FIG. 2. In the holding position according to FIG. 1 the flexible holding zone 1, 2 in this embodiment is spread out to a maximum surface area and is stretched between the opposite side walls 5, so the load placed on the load surface 6 cannot move in the cargo area.

Starting from this extended holding position according to FIG. 1, the flexible holding zone 1, 2 can move into the folded storage position according to FIG. 2, namely using the gathering means 8 to 11, H. Thus, when moved from the extended holding position of FIG. 1 into the folded storage position according to FIG. 2, the flexible holding zone 1, 2 is folded up like an accordion. The gathering means 8 to 11, H effects this. At the end of this process, the flexible holding zone 1, 2 assumes the folded storage position according to FIG. 2. In the folded storage position, the flexible holding zone 1, 2 is at the upper edge of the holding zone 1, 2 directly below or adjacent the structural element 3. This way, the folded-up holding zone 1, 2 in the holding position, forms an opening through which can easily pass, for example, an operator walking on the load surface 6.

The gathering means 8 to 11, H has in the extended holding position a plurality of cables, 8, 9, 10, and 11 all connected to the lower edge of the holding zone 1, 2. The schematic representation in FIG. 3 shows that the individual gathering cables 8, 9, 10, 11 are spaced horizontally apart from one another at the lower edge of the holding zone 1, 2 and are each connected to the lower edge of the load zone 1, 2, in the present case at the lowest horizontally running strap 2 or the lowest horizontal strap 2. In addition, the gathering cables 8, 9, 10, 11 extending longitudinally parallel to each other as shown in FIG. 3 by a double-headed arrow in a gathering direction R. According to the invention, the gathering direction R extends predominantly vertically.

In addition, the gathering cables 8, 9, 10, 11 pass through respective deflectors 12, 13, 14, 15 at the upper edge of the flexible holding zone 1, 2. These deflectors 12, 13, 14, 15 are in a row at the upper edge of the holding zone 1, 2. The deflector 12 is the first one in the row.

The gathering cables 8, 9, 10, 11 extend to a coupling 16. The coupling 16 is above the previously referred to handle H. In addition, the coupling 16 is below the first deflector 12 of the row of deflectors 12, 13, 14, 15. In this way an operator can manually actuate the handle H to pull all the gathering cables 8, 9, 10, 11 synchronously so that, in a gathering process in the gathering direction R indicated in FIG. 3, the lowest horizontally extending strap 2 of the flexible holding zone 1, 2 extending parallel to the load surface 6 moves, with increasing spacing in the direction R toward the structural element 3 at the upper edge of the flexible holding zone 1, 2. As a result, the flexible holding zone 1, 2 folds together like an accordion until it reaches the folded storage position shown in FIG. 2.

The handle H is equipped with a fastener 17 The fastener 17 can be releasably fixed at different fixing points. For example, the handle H together with the fastener 17 can be anchored to the side wall of the first deflector 12 in the row of deflectors 12 to 15. In this way, the gathering means 8 to 11, H is kept tensioned and keeps the flexible holding zone 1, 2 at the same time as shown in FIG. 2 in the folded storage position. When the gathering means 8 to 11, H is released, the flexible holding zone 1, 2 drops by gravity from the folded storage position shown in FIG. 2 to the spread-out holding position of FIG. 1.

The gathering cables 8 to 11 are part of the embodiment and not restricted to steel cables or plastic cables. Alternatively, one can use a plastic tape or several plastic tapes as well as combinations thereof. The gathering cables 8 to 11 are guided additionally through the flexible holding zone 1, 2, typically in the gathering direction R. For guidance according to the embodiment, guides 18, for example loops or eyelets 18, are formed in or connected as shown the illustration in the holding zone 1 and 2 in the vertically extending plastic straps 1. In addition, one recognizes in particular from FIG. 1, that the load-stabilizing web is divided as a whole or open, transversely to its longitudinal extent.

For this purpose, clamps 19 are provided with whose help not the horizontally running straps 2, 3 can be lengthened or shortened at a separation point indicated by a dashed line in FIG. 1, and the flexible holding zone 1, 2 can be stretched tight between the two walls 5. In any case, the clamps 19 can open and close the horizontal extending plastic straps 2, 3 in the area of the separation point and can stretch the loading zone 1, 2. At the same time, the flexible holding zone 1, 2 can be relaxed with the help of the clamps 19. In this way, each edge of the holding zone 1, 2 is provided with attachment fittings 7 that can be easily attached to the holes in the walls 5 or removed therefrom.

In addition it is possible for the gathering means 8 to 11, H to move the relaxed flexible holding zone 1, 2 as a whole into the folded storage position. For this purpose, the fastener 17 on the handle H on the side wall 5 of the first deflector 12 side wall 5 is detached and engaged with a hook 20 adjacent the separation point t. In this way the web is secured in the folded storage position aligned in the longitudinal direction of the load surface 6. Then the attachment fittings 7 are simply engaged on the opposite side walls 5 or in the associated seats. Only then is the connected flexible holding zone 1, 2 tightened with the help of the clamps 19.

1. A load-stabilizing web for securing a load during transport in a cargo area of a vehicle, the web comprising:
a variable-size, flexible holding zone, having side edges;
attachment fittings on the side edges for releasable fixation of the holding zone on side walls of the vehicle; and
gathering means for moving the flexible holding zone between an extended holding position and a folded storage position.

2. The load-stabilizing web according to claim 1, wherein the gathering means has at least one gathering cable connected to an upper edge of the load zone.

3. The load-stabilizing web according to claim 2, wherein the gathering means also comprises at least one deflector for the gathering cables at an upper edge of the holding zone.

4. The load-stabilizing web according to claim 2, wherein an end of the gathering cable is provided with a handle.

5. The load-stabilizing web according to claim 2, wherein a plurality of the gathering cables together are connected together at the upper edge of the holding zone.

6. The load-stabilizing web after claim 5, wherein the gathering cables are spaced from each other at the upper edge of the holding zone.

7. The load-stabilizing web according to claim 6, wherein the gathering cables extend parallel to one another in a gathering direction; and the web further comprising deflectors at the upper edge and through the deflectors which the cables pass.

8. The load-stabilizing web according to claim 6, further comprising:
a coupling connected to all of the gathering cables.

9. The load-stabilizing web according to claim 8, wherein the coupling is above a handle.

10. The load-stabilizing web according to claim 7, wherein the deflectors are spaced apart in a row at the upper edge of the holding zone.

11. The load-stabilizing web according to claim 8, wherein the coupling is below a first one of the deflectors in the row.

12. The load-stabilizing web according to claim 2, further comprising:
respective guides on the holding zone through which pass the gathering cables the gathering direction through respective guides.

13. The load-stabilizing web according to claim 2, wherein each gathering cable is a steel cable, plastic cable, plastic tape, or combination thereof.

14. The load-stabilizing web according to claim 1, wherein a rigid safety bar is provided at least at the upper edge of the flexible holding zone.

15. The load-stabilizing web according to claim 4, wherein the handle is provided with a fastener for detachable fixation, for example the side wall.
